(19) United States
(12) Patent Application Publication
(10) Pub. No.: US 2026/0343068 A1
(43) Pub. Date: Oct. 29, 2026

(54) VIDEO GENERATION METHOD AND APPARATUS, DEVICE, AND COMPUTER READABLE STORAGE MEDIUM

(71) Applicant: SHANGHAI XIYU JIZHI TECHNOLOGY CO., LTD., Shanghai (CN)

(72) Inventors: Yucong Zhou, Shanghai (CN); Zhihao Wang, Shanghai (CN); Bin Yang, Shanghai (CN)

(21) Appl. No.: 19/117,662

(22) PCT Filed: Dec. 29, 2022
(86) PCT No.: PCT/CN2022/143214

§ 371 Date: Apr. 2, 2025

(30) Foreign Application Priority Data
Oct. 9, 2022 (CN) 202211231054.X

(51) Int. Cl. H04N 21/81; G06V 10/74; G06V 10/80

(52) U.S. Cl. CPC H04N 21/816; G06V 10/761; G06V 10/803

(57) ABSTRACT

Disclosed in the present invention are a video generation method and apparatus, a device, and a computer readable storage medium. The method comprises: acquiring first information of a plurality of sampling points on first light; acquiring second information of a plurality of first key points of a target object multiple times; respectively generating a plurality of first key point fused features according to the first information and the second information; respectively offsetting spatial coordinates of the plurality of sampling points on the basis of the first key point fused features; inputting, in pairs, the offset spatial coordinates of the plurality of sampling points and the plurality of first key point fused features corresponding to the plurality of sampling points into a pre-trained neural radiation field model to obtain a plurality of static images of the target object; and synthesizing the images into a video of the target object.

### CROSS-REFERENCE TO RELATED APPLICATIONS

The present disclosure claims the priority to the Chinese patent application with the filling No. 202211231054X, filed on Oct. 9, 2022, the entire content of which is incorporated herein by reference for all purposes.

### TECHNICAL FIELD

The present disclosure relates to the technical field of computer vision, and particularly to a video generation method and apparatus, a device, and a computer-readable storage medium.

### BACKGROUND ART

In recent years, computer vision technology based on deep learning has achieved significant development in scenarios such as object tracking and image segmentation. Among them, research on the reconstruction and rendering of 3D scenes has also made great progress. Neural radiance field (NeRF) is a continuous and implicit representation of three-dimensional static scenes, which flexibly represents the geometry and appearance of three-dimensional scenes and enables realistic novel-view two-dimensional image synthesis. However, NeRF can only obtain two-dimensional images, which cannot meet the demand for three-dimensional video reconstruction.

For three-dimensional video synthesis, existing technologies typically add a time parameter to the training of neural networks based on 5D, thereby obtaining 3D images at any time and synthesizing videos. However, this method directly increases one dimension, significantly increasing the amount of training data and training time, which has low efficiency. Another commonly used method achieves 3D video generation for dynamic scenes based on time-dependent latent codes.

Therefore, the current 3D video generation mainly directly or indirectly depends on time, and thus, there is an urgent need to propose a video generation method that does not rely on time parameters.

### SUMMARY

The main objective of the present disclosure is to provide a video generation method and apparatus, a device, and a computer-readable storage medium, aiming to solve the technical problem that existing video generation methods rely on time parameters. The technical solution is as follows.

In a first aspect, the embodiments of the present disclosure provide a video generation method, including:
acquiring first information of multiple sampling points on first light ray, wherein the first information includes spatial coordinates and an orientation viewing angle;
acquiring second information of multiple first key points of a target object multiple times, wherein the second information includes spatial coordinates of the key points and features of the key points;
respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points;
performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, wherein the first sampling point is any one of the sampling points among the multiple sampling points;
inputting, in pairs, the offset spatial coordinates of the multiple sampling points and the multiple first key point fused features corresponding to the multiple sampling points into a pre-trained NeRF model to obtain multiple static images of the target object for the second information of the multiple first key points acquired each time, wherein the number of the multiple static images is equal to the number of times the second information of the first key points is acquired; and synthesizing the multiple static images into a video of the target object.

In a second aspect, the embodiments of the present disclosure provide a video generation apparatus, including:
a light ray acquisition module, configured for acquiring first information of multiple sampling points on first light ray, wherein the first information includes spatial coordinates and an orientation viewing angle;
a key point acquisition module, configured for acquiring second information of multiple first key points of a target object multiple times, wherein the second information includes spatial coordinates of the key points and features of the key points;
a key point encoding module, configured for respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points;
a light ray bending module, configured for performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, wherein the first sampling point is any one of the sampling points among the multiple sampling points;
a neural radiance field module, configured for inputting, in pairs, the offset spatial coordinates of the multiple sampling points and the multiple first key point fused features corresponding to the multiple sampling points into a pre-trained NeRF model to obtain multiple static images of the target object for the second information of the multiple first key points acquired each time, wherein the number of the multiple static images is equal to the number of times the second information of the first key points is acquired; and
a video generation module, configured for synthesizing the multiple static images into a video of the target object.

In a third aspect, the embodiment of the present disclosure provides an electronic device, comprising: a memory, a processor, and a computer program stored in the memory and executable on the processor, wherein the computer program, when executed by the processor, implements the steps of the method as described above.

In a fourth aspect, an embodiment of the present disclosure provides a computer storage medium, wherein the computer storage medium stores multiple instructions, and the instructions are adapted to be loaded by a processor and executed to perform the steps of the method as described above.

In the embodiment of the present disclosure, by acquiring the spatial coordinates and orientation viewing angle information of multiple sampling points on first light ray, acquiring multiple first key points of a target object, and then acquiring second information of the first key points multiple times, wherein the second information includes spatial coordinates of the key points and features of the key points, each sampling point on the first light ray is fused with the second information obtained each time to generate a first key point fused feature. Based on the first key point fused feature, an offset operation is performed on the spatial coordinates of each sampling point to obtain offset spatial coordinates of each sampling point. The offset spatial coordinates of the sampling points and the first key point fused features are input into a pre-trained neural radiance field model to generate a static image corresponding to each sampling point, wherein a corresponding static image is generated for the second information of the multiple first key points input each time. The multiple static images are synthesized into a video. By sequentially inputting the second information of the multiple first key points of the target object, when generating a static image corresponding to first light ray based on the neural radiance field, each static image is actually associated with the second information of different key points input each time. By incorporating the varying second information of the key points to simulate changes in each image within the dynamic scene, and then synthesizing the video based on the generated pictures, 3D video synthesis is achieved while being decoupled from time. The synthesis method is simple, requiring only a user-specified viewing angle to synthesize the video of the target object.

### BRIEF DESCRIPTION OF DRAWINGS

In order to more clearly illustrate the embodiments of the present disclosure or the technical solution in the prior art, the drawings required to be used in the description of the embodiments or the prior art will be briefly introduced as follows. Obviously, the drawings described below are only some embodiments of the present disclosure. Those of ordinary skill in the art, without paying inventive labor, may also obtain other drawings according to these drawings.

FIG. 1 is an exemplary schematic diagram of a video generation method provided in an embodiment of the present disclosure;

FIG. 2 is a flowchart schematic diagram of a video generation method provided in an embodiment of the present disclosure;

FIG. 3 is a schematic diagram of key points in a video generation method provided in an embodiment of the present disclosure;

FIG. 4 is a schematic diagram of light ray bending based on key points in a video generation method provided in an embodiment of the present disclosure;

FIG. 5 is a detailed flowchart schematic diagram of generating multiple first key point fused features in a video generation method provided in an embodiment of the present disclosure;

FIG. 6 is an overall flowchart of a video generation method provided in an embodiment of the present disclosure;

FIG. 7 is a detailed flowchart schematic diagram of determining a first key point in a video generation method provided in an embodiment of the present disclosure;

FIG. 8 is a structural schematic diagram of a video generation apparatus provided in an embodiment of the present disclosure; and

FIG. 9 is a structural schematic diagram of a video generation device provided in an embodiment of the present disclosure.

### DETAILED DESCRIPTION OF EMBODIMENTS

The technical solutions in the embodiments of the present disclosure will be clearly and completely described below in conjunction with the drawings in the embodiments of the present disclosure. Obviously, the described embodiments are only a part of the embodiments of the present disclosure, and not all of the embodiments. Based on the embodiments in the present disclosure, all other embodiments obtained by those of ordinary skill in the art without making inventive efforts are within the scope of protection of the present disclosure.

The video generation apparatus can be a terminal device such as a mobile phone, computer, tablet, smart watch, or in-vehicle device, or it can be a module within a terminal device configured to implement the video generation method. The video generation apparatus can acquire first information of multiple sampling points on first light ray, wherein the first information includes spatial coordinates and an orientation viewing angle; acquire second information of multiple first key points of a target object for multiple times, wherein the second information includes spatial coordinates of the key points and features of the key points; respectively generate multiple first key point fused features according to the first information and the second information for the multiple sampling points and the second information of the multiple first key points acquired each time, wherein each first key point fused feature in the multiple first key point fused features corresponds to one sampling point among the multiple sampling points; perform, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, wherein the first sampling point is any one of the sampling point among the multiple sampling points; input, in pairs, the offset spatial coordinates of the multiple sampling points and the multiple first key point fused features corresponding to the multiple sampling points into a pre-trained NeRF model to obtain multiple static images of the target object for the second information of the multiple first key points acquired each time, wherein the number of the multiple static images is equal to the number of times the second information of the first key points is acquired; and synthesize the multiple static images into a video of the target object.

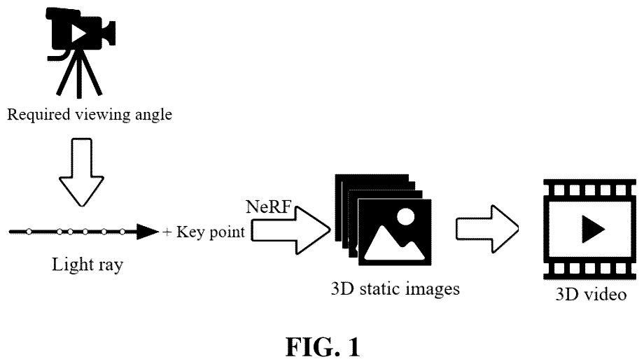

Referring to FIG. 1, FIG. 1 is an exemplary schematic diagram of a video generation method provided in the embodiment of the present disclosure. The process shown in the figure is for synthesizing a 3D video of a target object. In practical application scenarios, a light ray or, in other words, a shooting direction view can be obtained based on the desired viewing angle of the target object. Then, based on the key point information of the target object, the NeRF model is driven to obtain multiple 3D static pictures corresponding to the light ray. Afterward, a 3D video is synthesized from the multiple static pictures.

The video generation method provided in the present disclosure will now be described in detail in conjunction with specific embodiments.

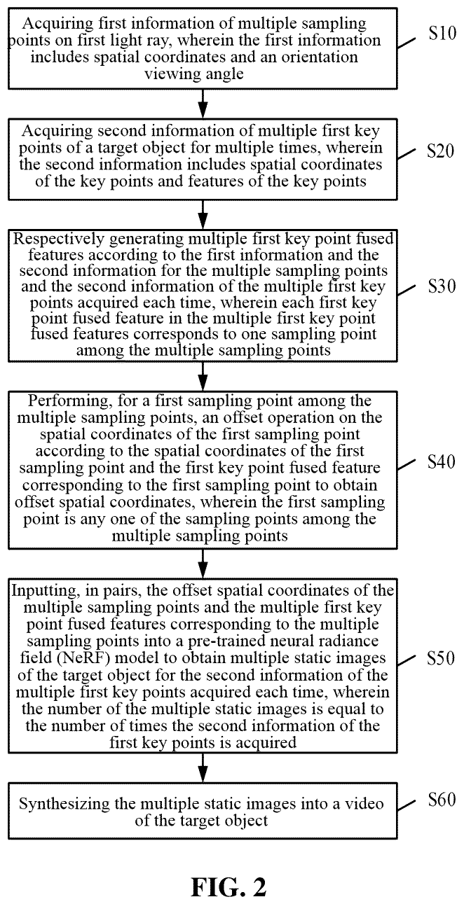

Referring to FIG. 2, FIG. 2 is a flowchart schematic diagram of a video generation method provided in an embodiment of the present disclosure. As shown in FIG. 2, the method of the embodiment of the present disclosure can include the following steps S10-S60.
S10: acquiring first information of multiple sampling points on first light ray, wherein the first information includes spatial coordinates and an orientation viewing angle.
S20: acquiring second information of multiple first key points of a target object multiple times, wherein the second information includes spatial coordinates of the key points and features of the key points.
S30: respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points.
S40: performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, wherein the first sampling point is any one of the sampling points among the multiple sampling points.
S50: inputting, in pairs, the offset spatial coordinates of the multiple sampling points and the multiple first key point fused features corresponding to the multiple sampling points into a pre-trained neural radiance field (NeRF) model to obtain multiple static images of the target object for the second information of the multiple first key points acquired each time, wherein the number of the multiple static images is equal to the number of times the second information of the first key points is acquired.
S60: synthesizing the multiple static images into a video of the target object.

In the embodiment, based on the traditional NeRF model, a 3D video synthesis method is provided. NeRF uses an MLP multi-layer perceptron to implicitly learn a static 3D scene. For each static 3D scene, a large number of pictures with known camera parameters are required to train the NeRF model. Once the NeRF model is trained, it can reconstruct a 3D model from any angle, such as for human bodies, buildings, vehicles, etc. The input to the model is 5D coordinates, and the 5D coordinates include three-dimensional spatial coordinates (x, y, z) and viewpoint direction d=(θ, φ). The output from the intermediate layer of the NeRF model includes color c and volume density σ (which can be approximately understood as opacity, with smaller values indicating higher transparency). The function can be understood as mapping the 5D coordinates to a color of the corresponding volume density and orientation. Then, volume rendering techniques are used to generate images. In rendering, for each light ray (which does not necessarily have to exist), a stereoscopic rendering method is applied to obtain the pixel value of this point. Specifically, many points are sampled along a light ray, and then the voxel and color corresponding to each point above are obtained. Next, the following rendering equation is used:

$$C ( r ) = {\int }_{{t}_{n}}^{{t}_{f}} T ( t ) σ ( r ( t ) ) c ( r ( t ) , d ) dt , where T ( t ) = exp ( - {\int }_{{t}_{n}}^{t} σ ( r ( s ) ) ds ) , r ( t ) = o + td ,$$

where tₙ and t_{f} represent the portion of the light ray that needs to be rendered in the scene, and the function T(t) represents the accumulated transmittance of the light ray from tn to t, that is, the probability that the light ray does not encounter any ions from tₙ to t. By integrating the light ray for each pixel of the virtual camera and computing C(r), views of the continuous neural radiance field can be visualized, thus rendering images from any angle.

The above describes using NeRF to reconstruct static 3D images. Clearly, the method does not produce dynamic 3D videos. In theory, by adding a time parameter to the 5D coordinates used in NeRF and training the neural network, 3D images at any time can be obtained, thus allowing the use of the time parameter to synthesize dynamic videos. However, this method directly introduces a new parameter, which significantly increases the data volume during training and extends training time, thereby lowering efficiency. Meanwhile, in the prior art, other methods for 3D video synthesis also require direct or indirect dependence on time parameters. Therefore, the present disclosure provides a 3D video synthesis method that decouples from time parameters, making the 3D video independent of time information and the order of each frame of the image in the video used during training.

Each step is described in detail below.
S10: acquiring first information of multiple sampling points on first light ray, wherein the first information includes spatial coordinates and an orientation viewing angle.

Specifically, the first light ray is a virtual light ray obtained based on the video viewing perspective. It can be considered as a light ray originating from a point such as a human eye or a camera and extending to the target object. In the step of acquiring first information of multiple sampling points on first light ray, the first information can include spatial coordinates and an orientation viewing angle of the sampling point. It can be understood that since the traditional NeRF model requires spatial coordinates and orientation viewing angles as input, the solution of the present disclosure similarly requires at least the spatial coordinates and orientation viewing angles of the sampling points.
S20: acquiring second information of multiple first key points of a target object for multiple times, wherein the second information includes spatial coordinates of the key points and features of the key points.

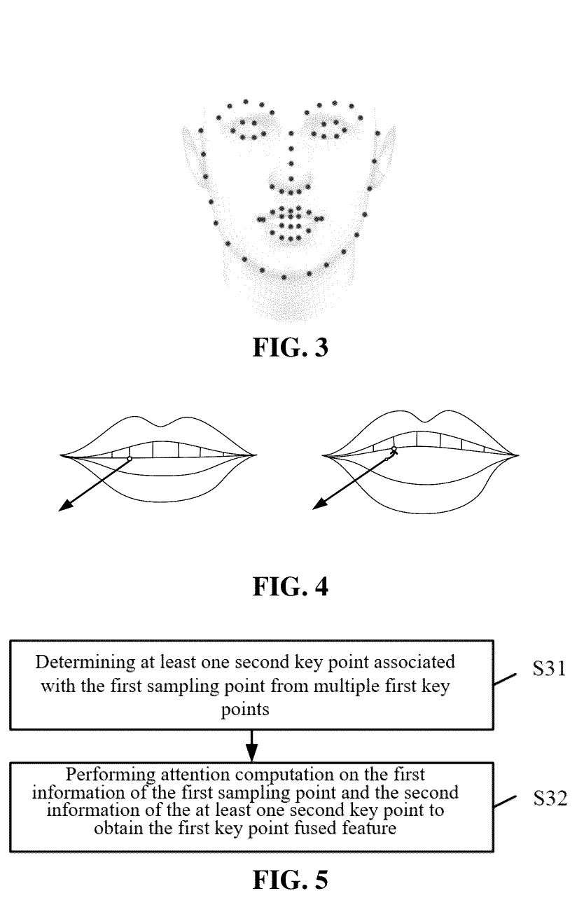

Specifically, the target object is the dynamic content to be included in the generated video, which can be an object, a person, a scene, etc. For example, if a video of a person speaking needs to be generated, the target object is the head of the person. When speaking, the person will change the facial expressions, such as lips opening and closing. By obtaining multiple first key points on the face of the person and tracking the specific changes in the spatial coordinates of these key points when the person is speaking, multiple second information of the first key points can be obtained. Referring to FIG. 3, FIG. 3 is a schematic diagram of key points in a video generation method provided in an embodiment of the present disclosure. The black dots in the figure represent key points on the head of the person. It can be understood that the number of key points can be determined based on the target object. Generally, the more first key points there are, the higher the accuracy of the simulated motion in the generated video is.

It should be noted that the features of the key points do not change; and what changes are the spatial coordinates of the key points.
S30: respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points.

Specifically, in a dynamic scene, the same key point moves its spatial position in space with different actions. The challenge of dynamic NeRF lies in simulating the dynamic changes under the same light ray angle. Referring to FIG. 4, FIG. 4 is a schematic diagram of light ray bending based on key points in a video generation method provided in an embodiment of the present disclosure. The marked dots in the figure represent a first key point on a tooth, and the light ray with an arrow in the figure is the first light ray. For example, in FIG. 4, if a closed mouth on the left needs to be changed to an open mouth on the right, the light ray must be bent so that the volume density and color of the position can still be obtained after the light ray is bent. In other words, during dynamic changes, some offsets are applied to the coordinate (x, y, z) of the originally static key point, which transforms it into (x′, y′, z′). This ensures that the key point still corresponds to the position of the tooth. Therefore, before bending the light ray, feature fusion is performed to associate or bind the sampling point coordinates on the first light ray with the coordinates of the key point and the features of the key point, thereby enabling NeRF to be driven by the key points. For example, to generate one picture, the first information of each sampling point on the first light ray and the second information of multiple first key points obtained at one time are fused separately to generate a first key point fused feature corresponding to each sampling point. The first key point fused feature includes not only the coordinates of the fused sampling point, the coordinates of the key point, and the feature information of the key point but also the orientation viewing angle of the sampling point.
S40: performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, wherein the first sampling point is any one of the sampling points among the multiple sampling points.

Specifically, after obtaining the first key point fused feature, the first light ray is bent, meaning that the coordinates of each sampling point on the light ray are offset. A first sampling point is obtained from multiple sampling points, and the spatial coordinates of the first sampling point, along with the corresponding first key point fused features of the first sampling point, are input into a trained light ray bending module. The offset spatial coordinates of the first sampling point are then obtained through the light ray bending module. The light ray bending module can be obtained through neural network training.
S50: inputting, in pairs, the offset spatial coordinates of the multiple sampling points and the multiple first key point fused features corresponding to the multiple sampling points into a pre-trained NeRF model to obtain multiple static images of the target object for the second information of the multiple first key points acquired each time, wherein the number of the multiple static images is equal to the number of times the second information of the first key points is acquired.

Specifically, in step S40, the coordinates of the offset key point are obtained and then combined with the first key point fused feature before being input into a trained NeRF model. Optionally, a multiresolution hash encoding (Hashgrid) scheme in InstantNG of NVIDIA can be used to optimize NeRF encoding. The reason for this is that traditional frequency encoding is an implicit encoding method, but Hashgrid is an explicit encoding method. Combining the two achieves better results and allows for the same rendering quality with lower computational cost. The pre-trained NeRF model outputs RGB values and volume density. Then, using volume rendering technology, a static image is generated based on the RGB values and volume density. Volume rendering technology is an available technology in the prior art and will not be further elaborated herein.
S60: synthesizing the multiple static images into a video of the target object.

For example, the generated static images are used as frames in the video, and the images are stitched together in sequence to obtain the video. It can be understood that, for example, if the generated video is a talking person, in the training process, a talking video of the person is collected and then performed by frame sampling (e.g., FPS=60); then, the spatial coordinates of the key points in each frame of the image is obtained, and the corresponding second information is generated. In the process of video synthesis, the second information of the multiple first key points is input in sequence, and the static images are correspondingly generated in sequence. The images are then directly stitched together to form the video. The stitching order of the images corresponds to the input order of multiple first key points, rather than the chronological order of frames in the video when training the NeRF model.

In the embodiment of the present disclosure, by acquiring the spatial coordinates and orientation viewing angle information of multiple sampling points on first light ray, acquiring multiple first key points of a target object, and then acquiring second information of the first key points multiple times, wherein the second information includes spatial coordinates of the key points and features of the key points, each sampling point on the first light ray is fused with the second information obtained each time to generate a first key point fused feature. Based on the first key point fused feature, an offset operation is performed on the spatial coordinates of each sampling point to obtain offset spatial coordinates of each sampling point. The offset spatial coordinates of the sampling points and the first key point fused features are input into a pre-trained neural radiance field model to generate a static image corresponding to each sampling point, wherein a corresponding static image is generated for the second information of the multiple first key points input each time. The multiple static images are synthesized into a video. By sequentially inputting the second information of the multiple first key points of the target object, when generating a static image corresponding to first light ray based on the neural radiance field, each static image is actually associated with the second information of different key points input each time. By incorporating the varying second information of the key points to simulate changes in each image within the dynamic scene, and then synthesizing the video based on the generated pictures, 3D video synthesis is achieved while being decoupled from time. The synthesis method is simple, requiring only a user-specified viewing angle to synthesize the video of the target object.

Referring to FIG. 5, FIG. 5 is a detailed flowchart schematic diagram of generating multiple first key point fused features in a video generation method provided in an embodiment of the present disclosure. As shown in FIG. 5, the method of the embodiment of the present disclosure can include the following steps S31-S32.
S31: determining at least one second key point associated with the first sampling point from multiple first key points.

In the embodiment, when generating the first key point fused feature, some second key points are selected from multiple first key points to perform feature fusion with the first information of the first sampling point. It is understandable that a sampling point P (x, y, z) in space is not necessarily associated with all key points landmark (x, y, z). For example, key points near the eyes drive eye movements, and key points near the mouth drive mouth movements. Key points near the eyes will not drive mouth movements. Therefore, it is necessary to select the second key points associated with the first sampling point from the first key points to make key point driving more accurate. Specifically, determining at least one second key point associated with the first sampling point from multiple first key points can be achieved by training a neural network. By inputting association features, the neural network learns the associated features of the key points and sampling points. Then, a trained neural network can perform correlation prediction to obtain the second key point from the first key points. Optionally, the corresponding relationship between the key points and the sampling points can also be set. When determining at least one second key point associated with the first sampling point from multiple first key points, it can be obtained from the corresponding relationship mapping table.
S32: performing attention computation on the first information of the first sampling point and the second information of the at least one second key point to obtain the first key point fused feature.

Specifically, after determining the second key point associated with the first sampling point, the second information of the second key point and the first information of the first sampling point are performed by the attention computation. This associates the first sampling point with the second key point. After passing through the attention mechanism, i.e., “attention”, the obtained first key point fused feature, i.e., “feature”, represents the feature after the interaction between the key point information of the target object and the light ray information.

For example, after determining the second key point associated with the first sampling point, the second information of the second key point and the first information of the first sampling point are performed by the attention computation. This associates the first sampling point with the second key point. After passing through the attention mechanism, i.e., “attention”, the obtained first key point fused feature, i.e., “feature”, represents the feature of the interaction between the key point information of the target object and the light ray information. Using point P to represent the sampling point, P (x, y, z) and landmark (x, y, z) are actually points in the same space. Since the influence of key points on P (x, y, z) is related to their spatial positions, a cross-attention-based encoding method is adopted, as shown below.

The sampling point P (x, y, z) is a 1×3 tensor and is used as a “query”.

The landmark (x, y, z) is an M×3 tensor and is used as a “key”.

Considering that the M landmarks have corresponding semantics, each landmark (x, y, z) is assigned a “landmark feature” correspondingly, represented as an M×3 embedding, which is used as a “value”.

By performing an attention operation on the query, key, and value, the final landmark encoding (i.e., the key point fused feature) is obtained.

Further, in one embodiment, the step of determining at least one second key point associated with the first sampling point from multiple first key points includes:
S311, calculating the distance between the spatial coordinates of the first sampling point and the spatial coordinates of multiple first key points; and
S312, determining at least one first key point with a distance less than or equal to a preset threshold as the at least one second key point.

Specifically, the distance between the first sampling point P (x, y, z) and all the first key points landmark (x, y, z) is computed. At least one first key point with a distance less than or equal to the preset threshold is determined as the at least one second key point associated with the first sampling point. The operation, Q multiplied by K, in the following formula represents a similarity, which is also an approach to measure distance. It should be noted that the attention computation “attention” can directly use an existing formula from prior art, and the specific formula is as follows:

$$Output = Softmax ( \frac{{QK}^{T}}{\sqrt{{d}_{k}}} ) V$$

where Q is the coordinates (x, y, z) of the input sampling point, K is the landmark coordinates (x, y, z), V is the learnable landmark feature (where the term “learnable” means that it is initialized to some random values, and then these random values can be updated as the network parameters are updated during training), and dₖ is the embedding dimension of Q or K. For example, if Q is 200×2048, and K and V are also 200×2048, then dₖ=2048.

Further, in one embodiment, the method of the embodiment of the present disclosure can include the following steps S33-S34:
S33, determining at least one second key point associated with the first sampling point from multiple first key points; and
S34: stitching the first information of the first sampling point and the second information of the at least one second key point to generate the first key point fused feature.

In one embodiment, the method for generating the first key point fused feature after determining the second key point from multiple first key points includes: stitching the first information of the first sampling point and the second information of the at least one second key point. Specifically, the coordinates (x, y, z) of the second key point are directly transformed into a one-dimensional vector and then stitched with the first sampling point P (x, y, z). This stitched vector is then used as an input to the subsequent NeRF model. It should be noted that directly stitching the coordinates of the key point with the coordinates of the sampling point for feature fusion is less effective than performing feature fusion through attention mechanisms. However, this method is simple and fast. When the quality requirements for synthesizing the target video are not high, this method can be used to improve the speed of the video generation.

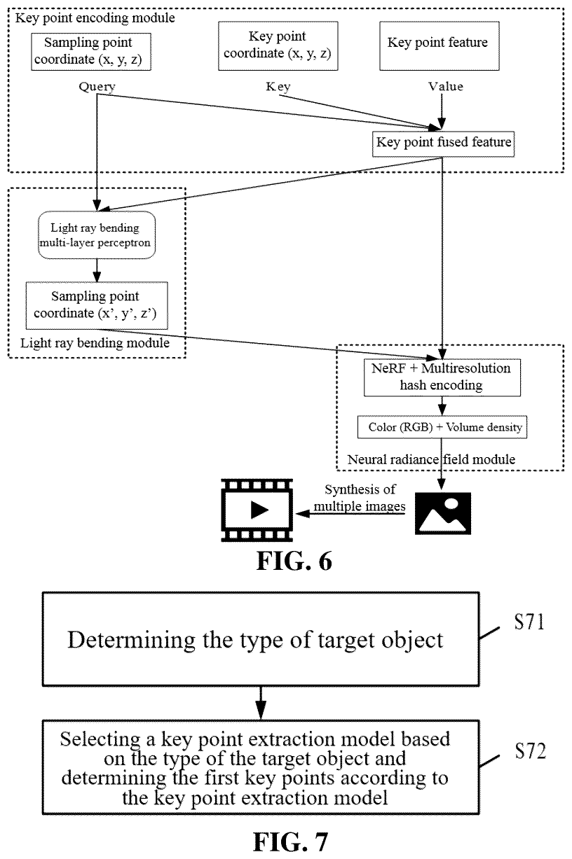

Referring to FIG. 6, FIG. 6 is an overall flowchart of a video generation method provided in an embodiment of the present disclosure. FIG. 6 illustrates the processing of each first sampling point (i.e., the sampling point in the figure) and the second information of a first key point (i.e., the key point in the figure) that is correspondingly acquired. The core processing modules include: a key point encoding module, a light ray bending module, and a neural radiance field module. First, the sampling point coordinates are used as “Query”, the key point coordinates as “Key”, and the features of the key point as “Value”. These are fused through an attention mechanism to obtain the key point fused feature. It should be noted that the orientation viewing angle of the sampling point is implicitly included in the fused feature for subsequent input into the NeRF model. Then, the key point fused feature and the coordinates of the sampling point are input into the light ray bending multi-layer perceptron within the light ray bending module, which outputs the coordinates of the offset sampling point. Next, the coordinates of the offset sampling point and the key point fused feature are input into the neural radiance field module. The NeRF, combined with Hashgrid, generates the color (RGB) and volume density for each sampling point. All the first sampling points on the first light ray are input into the above modules to obtain the RGB values and volume densities of all sampling points on the first light ray. A static picture is generated based on the RGB values and volume densities of all sampling points. The number of static pictures is equal to the number of times the second information of the first key points is acquired. Then, a video is generated by combining the obtained multiple static pictures.

In the embodiment, when generating the first key point fused feature, a second key point associated with the first sampling point is selected from multiple first key points. The second information of the second key point and the first information of the first sampling point are then fused to generate the first key point fused feature. Specifically, the first key point fused feature is generated by performing attention computation on the first information of the first sampling point and the second information of the at least one second key point or directly stitching the first information of the first sampling point and the second information of the at least one second key point. This enables the interaction between key point information and sampling point information on the light ray, allowing the subsequent neural radiance field model to generate the corresponding picture based on the input key point information.

Referring to FIG. 7, FIG. 7 is a detailed flowchart schematic diagram of determining a first key point in a video generation method provided in an embodiment of the present disclosure. As shown in FIG. 7, the method of the embodiment of the present disclosure can include the following steps S71-S72.
S71: determining the type of target object.

In one embodiment, the target object can belong to different types, and the different types of target objects require different key points to be extracted. It can be understood that if the target object is a head portrait of a person, it is necessary to obtain the key points corresponding to the head portrait of the person; if the target object is an animal, it is necessary to obtain the key points corresponding to the animal; or, if the target object is a human limb, it is necessary to obtain the key points corresponding to the limb. Specifically, the classification of the target object type can be determined based on actual conditions.
S72: selecting a key point extraction model based on the type of the target object and determining the first key points according to the key point extraction model.

In one embodiment, after determining the type of the target object, the key point extraction model of the target object is obtained, and the first key points are obtained through the key point extraction model. The key point extraction model can adopt an existing open-source model or be trained through a convolutional neural network. For example, the facial key point extraction model can adopt the popular open-source library Dlib for facial recognition. Assuming the target object is a human face, using the Dlib key point extraction model allows extracting 68 key points on the human face in the input picture.

Optionally, the present disclosure further provides a training method for a neural radiance field model used for video generation, including the following steps S81-S82:
S81, creating an initialized neural radiance field model; and
S82, training the initialized neural radiance field model using pre-acquired training images to obtain a trained neural radiance field model, wherein each training image is annotated with the first information of the sampling points, the spatial coordinates of all key points, and the features of the key point.

Specifically, since the neural radiance field model in the present disclosure differs from traditional neural radiance field models, of which the input data further includes key point information, it is necessary to create an initialized neural radiance field model and train the model using training images so that the neural radiance field model learns the first information of sampling points, the spatial coordinates of all key points, and the features of the key point. The pre-acquired training images are images extracted from a video. For example, if the target to be synthesized is a video of a person walking from a side perspective, during training, pictures can be extracted from a video of a person walking taken from the side view. For instance, 30 pictures can be extracted from a 1-second video. Each picture is annotated with 100 key points, and the spatial positions of the key points and features of the key points in each picture are obtained, thereby generating key point information corresponding to each picture. Next, the multiple sampling points on the light rays corresponding to the side view, along with each key point information, are performed by feature fusion, and the sampling points are offset. The offset spatial coordinates of the multiple sampling points and the corresponding key point fused features for the multiple sampling points are paired and input into the initialized neural radiance field (NeRF) model, thereby generating an experimental image. The experimental image is compared with the training image corresponding to the key point information used during training, and the neural radiance field model is trained by iteratively calculating the loss function.

Optionally, in the present disclosure, the steps of performing feature fusion and bending the spatial coordinate can be realized by the key point encoding module and the light ray bending module, respectively. The corresponding key point encoding model and light ray bending model can be trained together with the neural radiance field model. An exemplary training process can be as follows:
acquiring training video data and performing frame sampling on the training video data to generate a training image set;
acquiring the spatial coordinates and orientation viewing angles of all pixels in each image of the training image set, extracting the key points of each image in the training image set, and inputting the spatial coordinates, the orientation viewing angles, and the key points into the initial key point encoding model to obtain the initial key point fused feature;
inputting the initial key point fused feature and spatial coordinates into the initial light ray bending model, and outputting the initial corrected 3D coordinates;
inputting the initial corrected 3D coordinates and initial key point-driven features into the initialized neural radiance field model to render and generate the experimental image; and
iteratively calculating the preset loss function based on the experimental image and the training image set, and when the loss function meets the preset conditions, obtaining the key point encoding model, the light ray bending model, and the neural radiance field model by training.

Further, in one embodiment, a multi-layer perceptron is used to implement the step of performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates.

It can be understood that when a person is speaking or their face moves, the key points on the face also move. Then what is to be achieved is that the light ray moves with the key point. Specifically, through the multi-layer perceptron (MLP), the shift of the light ray is automatically learned, and the direction in which the light ray shifts is determined based on the information provided by the key points so that the shifted position of the key points is obtained. During training, constraints are set to ensure that the coordinates generated in a frame match the actual positions of the lips and teeth in the same frame. That is, the model is trained by comparing the generated pictures with the original pictures (training pictures).

Further, in one embodiment, the multi-layer perceptron can also be used to implement the step of respectively generating multiple first key point fused features according to the first information and the second information for the multiple sampling points and the second information of the multiple first key points acquired each time, The specific training method is similar to the above steps, and is not elaborated herein.

In the embodiment of the present disclosure, by determining the type of the target object and then selecting a key point extraction model based on the type of the target object, the first key point can be determined according to the key point extraction model. By matching the corresponding key point extraction models for different types of target objects, more accurate key point information can be provided for the target object in the generated video, thereby improving the accuracy of video synthesis. At the same time, by using a pre-trained key point extraction model to extract key points, without the need for temporary manual key point annotation, the efficiency of key point information collection is improved, making the video generation process faster.

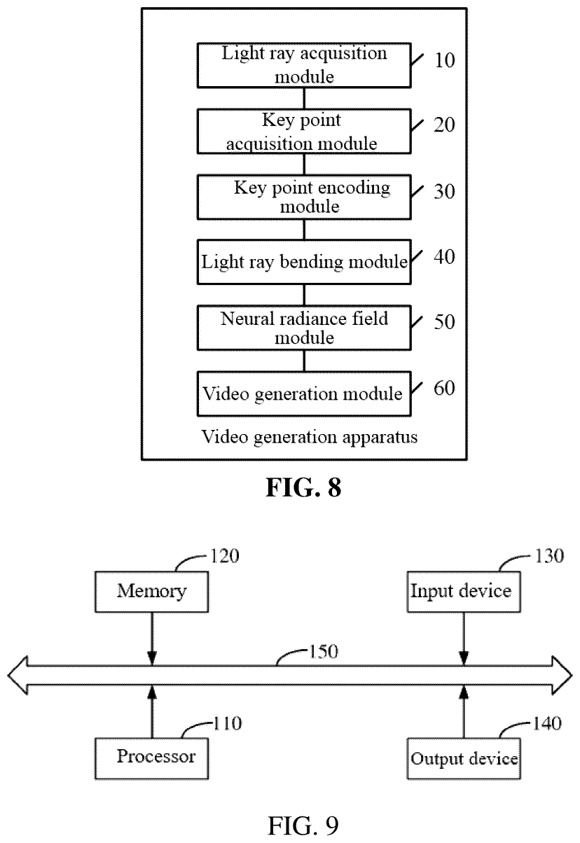

The following will provide a detailed description of the video generation apparatus in the embodiment of the present disclosure in conjunction with FIG. 8. It should be noted that the video generation apparatus in FIG. 8 is configured to execute the method of the embodiments shown in FIG. 2 to FIG. 7 of the present disclosure. For the sake of clarity, only the parts relevant to the embodiments of the present disclosure are shown. For specific technical details that are not disclosed here, the embodiments, shown in FIG. 2 to FIG. 7 of the present disclosure, can be referred to.

Referring to FIG. 8, FIG. 8 is a structural schematic diagram of a video generation apparatus provided in an embodiment of the present disclosure. The video generation apparatus can be implemented entirely or partially through software, hardware, or a combination of both. The apparatus includes a light ray acquisition module 10, a key point acquisition module 20, a key point encoding module 30, a light ray bending module 40, a neural radiance field module 50, and a video generation module 60.

The light ray acquisition module 10 is configured for acquiring first information of multiple sampling points on first light ray, wherein the first information includes spatial coordinates and an orientation viewing angle.

The key point acquisition module 20 is configured for acquiring second information of multiple first key points of a target object for multiple times, wherein the second information includes spatial coordinates of the key points and features of the key points.

The key point encoding module 30 is configured for respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points.

The light ray bending module 40 is configured for performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, wherein the first sampling point is any one of the sampling points among the multiple sampling points.

The neural radiance field module 50 is configured for inputting, in pairs, the offset spatial coordinates of the multiple sampling points and the multiple first key point fused features corresponding to the multiple sampling points into a pre-trained NeRF model to obtain multiple static images of the target object for the second information of the multiple first key points acquired each time, wherein the number of the multiple static images is equal to the number of times the second information of the first key points is acquired.

The video generation module 60 is configured for synthesizing the multiple static images into a video of the target object.

Optionally, the key point encoding module 30 is specifically configured for: determining, for the first sampling points and the second information of the multiple first key points acquired each time,
at least one second key point associated with the first sampling point from multiple first key points; and
performing attention computation on the first information of the first sampling point and the second information of the at least one second key point to obtain the first key point fused feature.

Optionally, the key point encoding module 30 is specifically configured for: determining, for the first sampling points and the second information of the multiple first key points acquired each time,
at least one second key point associated with the first sampling point from multiple first key points; and
stitching the first information of the first sampling point and the second information of the at least one second key point to generate the first key point fused feature.

Optionally, the key point encoding module 30 is specifically configured for calculating the distance between the spatial coordinates of the first sampling point and the spatial coordinates of multiple first key points; and
determining at least one first key point with a distance less than or equal to a preset threshold as the at least one second key point.

Optionally, by using the multi-layer perceptron, the key point encoding module 30 executes the operation of respectively generating multiple first key point fused features according to the first information and the second information for the multiple sampling points and the second information of the multiple first key points acquired each time.

Optionally, by using the multi-layer perceptron, the light ray bending module 40 executes the operation of performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates.

Optionally, the apparatus further includes a key point extraction module, wherein the key point extraction module is configured for determining the type of target object; and
selecting a key point extraction model based on the type of the target object and determining the first key points according to the key point extraction model.

It should be noted that the video generation apparatus provided in the above embodiments, when executing the video generation method, is described only by dividing the functional modules as mentioned above for illustrative purposes. In practical applications, the above functions can be allocated to different functional modules as needed, that is, the internal structure of the device can be divided into different functional modules to achieve all or part of the functions described above. Additionally, the video generation apparatus provided in the above embodiments and the video generation method embodiments belong to the same concept, and the implementation process is detailed in the method embodiments, which will not be elaborated on here.

The sequence numbers of the embodiments in the present disclosure are only for description purposes and do not indicate the superiority of the embodiments.

The present disclosure further provides a computer-readable storage medium, and a computer program is stored on the computer-readable storage medium. When executed by a processor, the computer program implements the video generation method of the embodiments as shown in FIGS. 2 to 7 above. The specific execution process can be referred to in the detailed description of the embodiments shown in FIGS. 2 to 7, which will not be elaborated on here.

Referring to FIG. 9, FIG. 9 shows a structural schematic diagram of a video generation device provided in an embodiment of the present disclosure. The video generation device in the present disclosure can include one or more of the following components: a processor 110, a memory 120, an input device 130, an output device 140, and a bus 150. The processor 110, the memory 120, the input device 130, and the output device 140 can be connected via the bus 150.

The processor 110 can include one or more processing cores. The processor 110 connects various components within the video generation device through various interfaces and circuits and various executes functions of the terminal 100 and processes data by running or executing instructions, programs, code sets, or instruction sets stored in the memory 120 and by calling data stored in the memory 120. Optionally, the processor 110 can be implemented in at least one hardware form selected from digital signal processing (DSP), field-programmable gate array (FPGA), and programmable logic array (PLA). The processor 110 can integrate one or a combination of a central processing unit (CPU), a graphics processing unit (GPU), and a modem. The CPU primarily processes the operating system, user interfaces, and applications. The GPU is configured for rendering and drawing display content. The modem is configured for processing wireless communication. It can be understood that the modem can also be implemented separately through a communication chip instead of being integrated into the processor 110.

The memory 120 can include random access memory (RAM), and it can also include read-only memory (ROM). Optionally, the memory 120 includes a non-transitory computer-readable storage medium. The memory 120 can be configured to store instructions, programs, code, code sets, or instruction sets. The memory 120 can include a program storage region and a data storage region. The program storage region can store instructions for implementing the operating system, instructions for implementing at least one function (such as a touch function, audio playback function, image playback function, etc.), and instructions for implementing the above method embodiments. The operating system can be an Android system, including systems developed based on the Android system, an iOS system developed by Apple, including systems developed based on the iOS system, or other systems.

The memory 120 can be divided into an operating system space and a user space, wherein the operating system runs in the operating system space, and native and third-party applications run in the user space. To ensure that different third-party applications achieve better operational performance, the operating system allocates corresponding system resources for each third-party application. However, different application scenarios within the same third-party application have different system resource demands. For example, in a local resource loading scenario, the third-party application requires a higher disk read speed; and in an animation rendering scenario, the third-party application requires higher GPU performance. Since the operating system and third-party applications operate independently, the operating system often cannot promptly perceive the current application scenario of the third-party application, leading to the inability of the operating system to perform targeted system resource adaptation based on the specific application scenario of the third-party application.

To enable the operating system to distinguish specific application scenarios of third-party applications, data communication between third-party applications and the operating system needs to be established so that the operating system can obtain the current scenario information of third-party applications at any time and subsequently perform targeted system resource adaptation based on the current scenario.

The input device 130 is configured to receive input instructions or data. The input device 130 can include, but is not limited to, a keyboard, a mouse, a camera, a microphone, or a touch device. The output device 140 is configured to output instructions or data. The output device 140 can include, but is not limited to, a display device and a speaker. In one example, the input device 130 and the output device 140 can be integrated, wherein the input device 130 and the output device 140 form a touch display screen.

The touch display screen can be designed as a full-screen, curved screen, or irregular screen. The touch display screen can also be designed as a combination of a full-screen and a curved screen or a combination of an irregular screen and a curved screen, which is not limited to the embodiments of the present disclosure.

Additionally, those skilled in the art can understand that the structure of the video generation device shown in the above figures does not limit the video generation device. The video generation device can include more or fewer components than illustrated, wherein some components can be combined, or the arrangement of components can be different. For example, the video generation device can further include components such as a radio frequency circuit, an input unit, a sensor, an audio circuit, a wireless fidelity (Wi-Fi) module, a power supply, and a Bluetooth module, which will not be elaborated on herein.

In the video generation device shown in FIG. 9, the processor 110 can be used to call a computer program stored in the memory 120 and specifically perform the following operations:
acquiring first information of multiple sampling points on first light ray, wherein the first information includes spatial coordinates and an orientation viewing angle;
acquiring second information of multiple first key points of a target object for multiple times, wherein the second information includes spatial coordinates of the key points and features of the key points;
respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points;
performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, wherein the first sampling point is any one of the sampling points among the multiple sampling points;
inputting, in pairs, the offset spatial coordinates of the multiple sampling points and the multiple first key point fused features corresponding to the multiple sampling points into a pre-trained NeRF model to obtain multiple static images of the target object for the second information of the multiple first key points acquired each time, wherein the number of the multiple static images is equal to the number of times the second information of the first key points is acquired; and synthesizing the multiple static images into a video of the target object.

In one embodiment, when executing the step of respectively generating multiple first key point fused features according to the first information and the second information for the multiple sampling points and the second information of the multiple first key points acquired each time, the processor 110 specifically performs the following operations:
determining, for the first sampling points and the second information of the multiple first key points acquired each time,
at least one second key point associated with the first sampling point from multiple first key points; and
performing attention computation on the first information of the first sampling point and the second information of the at least one second key point to obtain the first key point fused feature.

In one embodiment, when executing the step of respectively generating multiple first key point fused features according to the first information and the second information for the multiple sampling points and the second information of the multiple first key points acquired each time, the processor 110 specifically performs the following operations:
determining, for the first sampling points and the second information of the multiple first key points acquired each time,
at least one second key point associated with the first sampling point from multiple first key points; and
stitching the first information of the first sampling point and the second information of the at least one second key point to generate the first key point fused feature.

Further, in one embodiment, when executing the step of determining at least one second key point associated with the first sampling point from multiple first key points, the processor 110 specifically performs the following operations:
calculating the distance between the spatial coordinates of the first sampling point and the spatial coordinates of multiple first key points; and
determining at least one first key point with a distance less than or equal to a preset threshold as the at least one second key point.

In one embodiment, when executing the step of respectively generating multiple first key point fused features according to the first information and the second information for the multiple sampling points and the second information of the multiple first key points acquired each time, it is implemented by the processor 110 using a multi-layer perceptron.

In one embodiment, when executing the step of performing, for a first sampling point among the multiple sampling points, an offset operation on the spatial coordinates of the first sampling point according to the spatial coordinates of the first sampling point and the first key point fused feature corresponding to the first sampling point to obtain offset spatial coordinates, it is implemented by the processor 110 using a multi-layer perceptron.

In one embodiment, before the step of acquiring second information of multiple first key points of a target object multiple times, wherein the first key point is a human body key point, and the first key point includes a facial key point and a limb key point, the processor 110 further performs the following operations:
determining the type of target object; and
selecting a key point extraction model based on the type of the target object and determining the first key points according to the key point extraction model.

In the embodiment of the present disclosure, by acquiring the spatial coordinates and orientation viewing angle information of multiple sampling points on first light ray, acquiring multiple first key points of a target object, and then acquiring second information of the first key points multiple times, wherein the second information includes spatial coordinates of the key points and features of the key points, each sampling point on the first light ray is fused with the second information obtained each time to generate a first key point fused feature. Based on the first key point fused feature, an offset operation is performed on the spatial coordinates of each sampling point to obtain offset spatial coordinates of each sampling point. The offset spatial coordinates of the sampling points and the first key point fused features are input into a pre-trained neural radiance field model to generate a static image corresponding to each sampling point, wherein a corresponding static image is generated for the second information of the multiple first key points input each time. The multiple static images are synthesized into a video. By sequentially inputting the second information of the multiple first key points of the target object, when generating a static image corresponding to first light ray based on the neural radiance field, each static image is actually associated with the second information of different key points input each time. By incorporating the varying second information of the key points to simulate changes in each image within the dynamic scene, and then synthesizing the video based on the generated pictures, 3D video synthesis is achieved while being decoupled from time. The synthesis method is simple, requiring only a user-specified viewing angle to synthesize the video of the target object. In addition, when generating the first key point fused feature, a second key point associated with the first sampling point is selected from multiple first key points. The second information of the second key point and the first information of the first sampling point are then fused to generate the first key point fused feature. Specifically, the first key point fused feature is generated by performing attention computation on the first information of the first sampling point and the second information of the at least one second key point or directly stitching the first information of the first sampling point and the second information of the at least one second key point. This enables the interaction between key point information and sampling point information on the light ray, allowing the subsequent neural radiance field model to generate the corresponding picture based on the input key point information. Moreover, by determining the type of the target object and then selecting a key point extraction model based on the type of the target object, the first key point can be determined according to the key point extraction model. By matching the corresponding key point extraction models for different types of target objects, more accurate key point information can be provided for the target object in the generated video, thereby improving the accuracy of video synthesis. At the same time, by using a pre-trained key point extraction model to extract key points, without the need for temporary manual key point annotation, the efficiency of key point information collection is improved, making the video generation process faster.

Those of ordinary skill in the art can understand that the implementation of all or part of the processes in the above-described embodiment methods can be completed by instructing related hardware through a computer program. The program can be stored in a computer-readable storage medium; and when executed, the program can include the processes of the embodiment methods as described above. The storage medium can be a magnetic disk, an optical disk, a read-only memory (ROM), a random access memory (RAM), etc.

The above disclosure is merely a preferred embodiment of the present disclosure and should not be used to limit the scope of claims of the present disclosure. Therefore, equivalent changes made based on the claims of the present disclosure shall still fall within the scope covered by the present disclosure.

1. A video generation method, comprising:
acquiring first information of multiple sampling points on first light ray, wherein the first information comprises spatial coordinates and an orientation viewing angle;
acquiring second information of multiple first key points of a target object for multiple times, wherein the second information comprises spatial coordinates of the key points and features of the key points;
respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points;
performing, for a first sampling point among the multiple sampling points, an offset operation on spatial coordinates of the first sampling point according to the spatial coordinates of the first sampling point and a first key point fused feature corresponding to the first sampling point to obtain offset spatial coordinates, wherein the first sampling point is any one of the sampling points among the multiple sampling points;
inputting, in pairs, the offset spatial coordinates of the multiple sampling points and the multiple first key point fused features corresponding to the multiple sampling points into a pre-trained neural radiance field NeRF model to obtain multiple static images of the target object for the second information of the multiple first key points acquired each time, wherein the number of the multiple static images is equal to the number of times the second information of the first key points is acquired; and
synthesizing the multiple static images into a video of the target object.

2. The method according to claim 1, wherein the step of respectively generating multiple first key point fused features according to the first information and the second information for the multiple sampling points and the second information of the multiple first key points acquired each time comprises:
for the first sampling points and the second information of the multiple first key points acquired each time,
determining at least one second key point associated with the first sampling points from the multiple first key points; and
performing attention computation on the first information of the first sampling points and the second information of the at least one second key point to obtain the first key point fused feature.

3. The method according to claim 1, wherein the step of respectively generating multiple first key point fused features according to the first information and the second information for the multiple sampling points and the second information of the multiple first key points acquired each time comprises:
for the first sampling points and the second information of the multiple first key points acquired each time,
determining at least one second key point associated with the first sampling points from the multiple first key points; and
stitching the first information of the first sampling points and the second information of the at least one second key point to generate the first key point fused feature.

4. The method according to claim 2, wherein the step of determining at least one second key point associated with the first sampling points from the multiple first key points comprises:
calculating a distance between the spatial coordinates of the first sampling points and spatial coordinates of the multiple first key points; and
determining at least one first key point with the distance less than or equal to a preset threshold as the at least one second key point.

5. The method according to claim 2, wherein a multi-layer perceptron implements the step of respectively generating multiple first key point fused features according to the first information and the second information for the multiple sampling points and the second information of the multiple first key points acquired each time.

6. The method according to claim 1, wherein a multi-layer perceptron implements the step of performing, for a first sampling point among the multiple sampling points, an offset operation on spatial coordinates of the first sampling point according to the spatial coordinates of the first sampling point and a first key point fused feature corresponding to the first sampling point to obtain offset spatial coordinates.

7. The method according to claim 1, before the step of acquiring second information of multiple first key points of a target object for multiple times, wherein the first key point is a human body key point, and the first key point comprises a facial key point and a limb key point, further comprising:
determining a type of the target object; and
selecting a key point extraction model based on the type of the target object and determining the first key points according to the key point extraction model.

8. A video generation apparatus, comprising:
a light ray acquisition module, configured for acquiring first information of multiple sampling points on first light ray, wherein the first information comprises spatial coordinates and an orientation viewing angle;
a key point acquisition module, configured for acquiring second information of multiple first key points of a target object for multiple times, wherein the second information comprises spatial coordinates of the key points and features of the key points;
a key point encoding module, configured for respectively generating multiple first key point fused features according to the first information and the second information for the multiple sampling points and the second information of the multiple first key points acquired each time, wherein each first key point fused feature in the multiple first key point fused features corresponds to one sampling point among the multiple sampling points;
a light ray bending module, configured for performing, for a first sampling point among the multiple sampling points, an offset operation on spatial coordinates of the first sampling point according to the spatial coordinates of the first sampling point and a first key point fused feature corresponding to the first sampling point to obtain offset spatial coordinates, wherein the first sampling point is any one of the sampling points among the multiple sampling points;
a neural radiance field module, configured for inputting, in pairs, the offset spatial coordinates of the multiple sampling points and the multiple first key point fused features corresponding to the multiple sampling points into a pre-trained neural radiance field NeRF model to obtain multiple static images of the target object for the second information of the multiple first key points acquired each time, wherein the number of the multiple static images is equal to the number of times the second information of the first key points is acquired; and
a video generation module, configured for synthesizing the multiple static images into a video of the target object.

9. An electronic device, comprising a memory, a processor, and a computer program stored in the memory that can be executed on the processor, wherein, when executing the computer program, the processor implements the steps of the method according to claim 1.

10. A computer-readable storage medium, wherein the computer-readable storage medium stores multiple instructions, and the instructions are adapted to be loaded by a processor and executed to perform the steps of the method according to claim 1.

11. The electronic device according to claim 9, wherein the step of respectively generating multiple first key point fused features according to the first information and the second information for the multiple sampling points and the second information of the multiple first key points acquired each time comprises:
for the first sampling points and the second information of the multiple first key points acquired each time,
determining at least one second key point associated with the first sampling points from the multiple first key points; and
performing attention computation on the first information of the first sampling points and the second information of the at least one second key point to obtain the first key point fused feature.

12. The electronic device according to claim 9, wherein the step of respectively generating multiple first key point fused features according to the first information and the second information for the multiple sampling points and the second information of the multiple first key points acquired each time comprises:
for the first sampling points and the second information of the multiple first key points acquired each time,
determining at least one second key point associated with the first sampling points from the multiple first key points; and
stitching the first information of the first sampling points and the second information of the at least one second key point to generate the first key point fused feature.

13. The electronic device according to claim 11, wherein the step of determining at least one second key point associated with the first sampling points from the multiple first key points comprises:
calculating a distance between the spatial coordinates of the first sampling points and spatial coordinates of the multiple first key points; and
determining at least one first key point with the distance less than or equal to a preset threshold as the at least one second key point.

14. The electronic device according to claim 11, wherein a multi-layer perceptron implements the step of respectively generating multiple first key point fused features according to the first information and the second information for the multiple sampling points and the second information of the multiple first key points acquired each time.

15. The electronic device according to claim 9, wherein a multi-layer perceptron implements the step of performing, for a first sampling point among the multiple sampling points, an offset operation on spatial coordinates of the first sampling point according to the spatial coordinates of the first sampling point and a first key point fused feature corresponding to the first sampling point to obtain offset spatial coordinates.

16. The electronic device according to claim 9, before the step of acquiring second information of multiple first key points of a target object for multiple times, wherein the first key point is a human body key point, and the first key point comprises a facial key point and a limb key point, further comprising:
determining a type of the target object; and
selecting a key point extraction model based on the type of the target object and determining the first key points according to the key point extraction model.

17. The computer-readable storage medium according to claim 10, wherein the step of respectively generating multiple first key point fused features according to the first information and the second information for the multiple sampling points and the second information of the multiple first key points acquired each time comprises:
for the first sampling points and the second information of the multiple first key points acquired each time,
determining at least one second key point associated with the first sampling points from the multiple first key points; and
performing attention computation on the first information of the first sampling points and the second information of the at least one second key point to obtain the first key point fused feature.

18. The computer-readable storage medium according to claim 10, wherein the step of respectively generating multiple first key point fused features according to the first information and the second information for the multiple sampling points and the second information of the multiple first key points acquired each time comprises:
for the first sampling points and the second information of the multiple first key points acquired each time,
determining at least one second key point associated with the first sampling points from the multiple first key points; and
stitching the first information of the first sampling points and the second information of the at least one second key point to generate the first key point fused feature.

19. The computer-readable storage medium according to claim 17, wherein the step of determining at least one second key point associated with the first sampling points from the multiple first key points comprises:
calculating a distance between the spatial coordinates of the first sampling points and spatial coordinates of the multiple first key points; and
determining at least one first key point with the distance less than or equal to a preset threshold as the at least one second key point.

20. The computer-readable storage medium according to claim 10, before the step of acquiring second information of multiple first key points of a target object for multiple times, wherein the first key point is a human body key point, and the first key point comprises a facial key point and a limb key point, further comprising:
determining a type of the target object; and
selecting a key point extraction model based on the type of the target object and determining the first key points according to the key point extraction model.
